(19) United States
(12) Patent Application Publication
(10) Pub. No.: US 2026/0169520 A1
(43) Pub. Date: Jun. 18, 2026

(54) DISPLAY DEVICE CAPABLE OF ADJUSTING VIEW ANGLE AND ALL-IN-ONE COMPUTER HAVING THE SAME

(71) Applicant: Lanto Electronic Limited, Kunshan City (CN)

(72) Inventors: Kuei Jung YANG, Kunshan City (CN); CHIH HSIUNG CHANG, Kunshan City (CN); CIAO YIN YANG, Kunshan City (CN)

(21) Appl. No.: 19/372,800

(22) Filed: Oct. 29, 2025

(30) Foreign Application Priority Data
Dec. 18, 2024 (CN) 2024231365006

(51) Int. Cl. G06F 1/16; F16M 11/04; F16M 11/18

(52) U.S. Cl. CPC G06F 1/1607; F16M 11/046; F16M 11/18

(57) ABSTRACT

The invention provides a display device capable of adjusting view angle and an all-in-one computer having the same. The display device includes a base, a display, a horizontal angle adjusting device and a vertical angle adjusting device. The horizontal angle adjusting device includes a first motor, a transmission gear assembly and a cover. The first motor includes a first motor shaft and an active gear mounted to an end of the first motor shaft. A rack is formed in the transmission gear assembly. The vertical angle adjusting device includes a second motor mounted to a back portion of the display and an insertion portion formed at one side of the cover. The second motor has a second motor shaft secured to the insertion portion. The second motor operates to rotate the display vertically and the active gear engages the rack to rotate the display horizontally.

### CROSS-REFERENCE TO RELATED APPLICATIONS

This non-provisional application claims priority claim under 35 U.S.C. § 119(a) on China Patent Application No. 2024231365006 filed Dec. 18, 2024, the entire contents of which are hereby incorporated by reference.

### BACKGROUND OF THE INVENTION

### Field of the Invention

The invention relates to a technical field of display device, and more particularly to a display device capable of adjusting view angle and an all-in-one computer having the same.

### Description of the Related Art

A conventional all-in-one computer often allows a user to adjust a horizontal angle or a vertical angle of a display thereof. However, the horizontal angle and the vertical angle cannot be adjusted at the same time. Moreover, the conventional adjustment of the horizontal angle or the vertical angle of the display is operated manually. As the conventional all-in-one computer has no auto-adjustment function for the view angle of the display, the conventional all-in-one computer has therefore lack of intelligent functions and remote operation functions.

Moreover, a disclosed conventional view angle adjustment device for the display utilizes a horizontally-rotating device to adjust the horizontal angle thereof and a vertically-rotating device to adjust the vertical angle thereof.

### BRIEF SUMMARY OF THE INVENTION

An object of the present invention is to provide a display device capable of adjusting a view angle and an all-in-one computer having simple mechanisms for automatically adjusting a horizontal angle and a vertical angle of a display.

The invention provides a display device capable of adjusting a view angle. The display device in accordance with an exemplary embodiment of the invention includes a base, a display, a horizontal angle adjusting device being configured to adjust a horizontal angle of the display and comprising a first motor secured at the base, a transmission gear assembly and a cover secured in the transmission gear assembly, wherein the first motor comprises a first body, a first motor shaft and an active gear joined to an end of the first motor shaft, the transmission gear assembly comprises a rack, and the transmission gear assembly and the cover are rotatably mounted to the base, and a vertical angle adjusting device being configured to adjust a vertical angle of the display and comprising a second motor mounted to a back portion of the display and at least one insertion portion formed on one side of the cover, wherein the second motor comprises a second body and a second motor shaft, an end of the second motor shaft is secured to the insertion portion, the second body rotates with respect to the second motor shaft when the second motor is operated, whereby the display is rotated vertically. The active gear engages the rack of the transmission gear assembly to rotate the transmission gear assembly and the cover, thereby the display rotates horizontally.

The invention provides an all-in-one computer including a display device and a host. The display device includes a base, a display, a horizontal angle adjusting device being configured to adjust a horizontal angle of the display and comprising a first motor secured at the base, a transmission gear assembly and a cover secured in the transmission gear assembly, wherein the first motor comprises a first body, a first motor shaft and an active gear joined to an end of the first motor shaft, the transmission gear assembly comprises a rack, and the transmission gear assembly and the cover are rotatably mounted to the base, and a vertical angle adjusting device being configured to adjust a vertical angle of the display and comprising a second motor mounted to a back portion of the display and at least one insertion portion formed on one side of the cover, wherein the second motor comprises a second body and a second motor shaft, an end of the second motor shaft is secured to the insertion portion, the second body rotates with respect to the second motor shaft when the second motor is operated, whereby the display is rotated vertically. The active gear engages the rack of the transmission gear assembly to rotate the transmission gear assembly and the cover, thereby the display rotates horizontally. The host is disposed in the base or the display.

In comparison with the conventional technology, the display device of the present invention utilizes the second motor mounted to the back portion of the display and the insertion portion formed on one side of the cover for adjustment of the vertical angle thereof. The display device of the present invention also utilizes the active gear of the first motor and the rack of the transmission gear assembly for adjustment of the horizontal angle thereof.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a perspective view of an embodiment of an all-in-one computer of the present invention;

FIG. 2 is a side view of the all-in-one computer of FIG. 1, wherein a display is in an erected condition;

FIG. 3 is a side view of the all-in-one computer of FIG. 1, wherein the display is in a backward-inclined condition;

FIG. 4 is a side view of the all-in-one computer of FIG. 1, wherein the display faces a front side of the all-in-one computer;

FIG. 5 is a side view of the all-in-one computer of FIG. 1, wherein the display faces a right-hand side of the all-in-one computer;

FIG. 6 is a partially cross section of a horizontal angle adjusting device of the all-in-one computer of FIG. 1;

FIG. 7 is an exploded view of the horizontal angle adjusting device of the all-in-one computer of FIG. 1; and

FIG. 8 is an exploded view of the vertical angle adjusting device of the all-in-one computer of FIG. 1.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides an all-in-one computer having a simple structure is capable of automatically adjusting a vertical angle and a horizontal angle of a display.

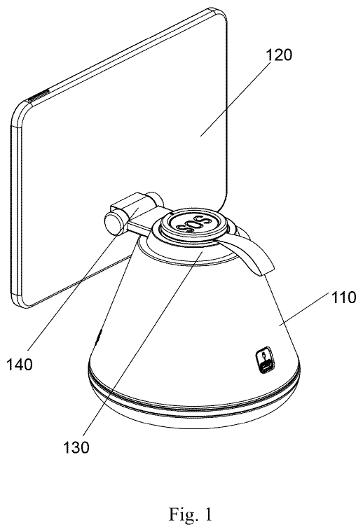

Referring to FIG. 1, the all-in-one computer includes a display device and a host. The display device includes a base 110, a display 120, a horizontal angle adjusting device 130 and a vertical angle adjusting device 140. The host is disposed in the base 110.

In an alternative embodiment, the host is disposed in the display 120, for example, the display 120 is a tablet. Certainly, the display 120 may have only display function.

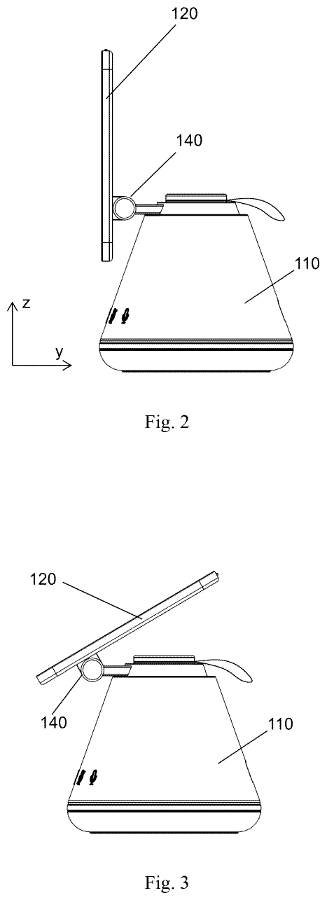

The vertical angle adjusting device 140 is configured to adjust a vertical angle of the display 120. FIG. 2 is a side view of the all-in-one computer of FIG. 1 in a condition, the display 120 extending along a z-axis, and FIG. 3 is a side view of the all-in-one computer of FIG. 1 in another condition, the display 120 inclined backwards. The vertical angle adjusting device 140 can adjust the display 120 from the condition shown in FIG. 2 to the condition shown in FIG. 3. Certainly, the vertical angle adjusting device 140 can further adjust the vertical angle of the display 120, for example, the display 120 is adjusted to be inclined forwards.

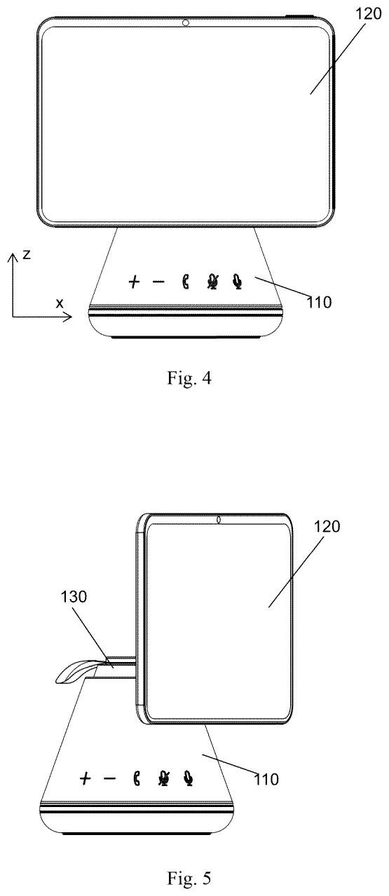

The horizontal angle adjusting device 130 is configured to adjust a horizontal angle of the display 120. FIG. 4 is a front view of the all-in-one compute of FIG. 1 in a condition, the display 120 facing a front side of the all-in-one computer, wherein an x-axis and a y-axis define a horizontal plane, and the z-axis is perpendicular to the horizontal plane. FIG. 5 is a front view of the all-in-one computer of FIG. 1 in another condition, the display 120 facing a right-hand side of the all-in-one computer. The horizontal angle adjusting device 130 can adjust the display 120 from the condition shown in FIG. 4 to the condition shown in FIG. 5. Certainly, the horizontal angle adjusting device 130 can further adjust the horizontal angle of the display 120, for example, the display 120 is adjusted to face a left-hand side of the all-in-one computer.

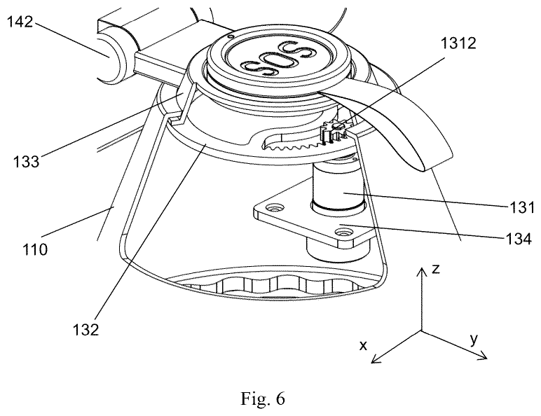

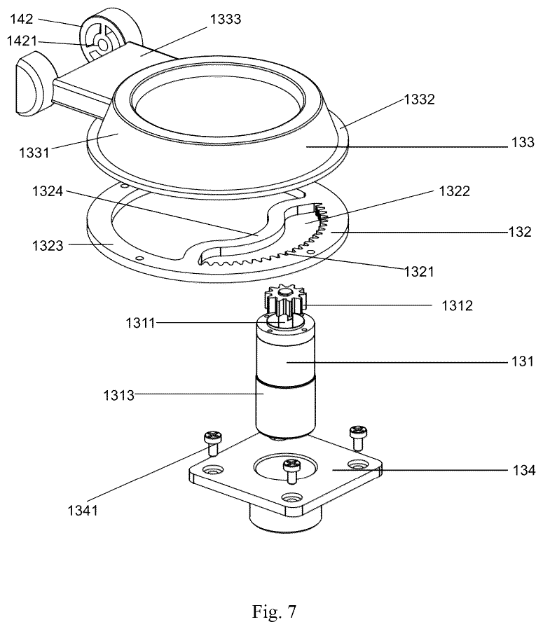

Referring to FIGS. 6 and 7, the horizontal angle adjusting device 130 includes a first motor 131 secured to the base 110, a transmission gear assembly 132 and a cover 133 secured to the transmission gear assembly 132. The first motor 131 includes a first body 1313, a first motor shaft 1311 and an active gear 1312 joined to an end of the first motor shaft 1311. A rack 1321 is formed in the transmission gear assembly 132. The transmission gear assembly 132 and the cover 133 are rotatably mounted to the base 110. The active gear 1312 engages with the rack 1321 of the transmission gear assembly 132 to rotate the transmission gear assembly 132 and the cover 133, and therefore rotate the display 120 horizontally. In one embodiment, when the first motor 131 rotates in a clockwise direction, the display 120 rotates to the left-hand side horizontally. When the first motor 131 rotates in a counter clockwise direction, the display 120 rotates to the right-hand side horizontally. In this way, the horizontal angle of the display 120 can be precisely adjusted through the rotation of the first motor 131.

As shown in FIGS. 6 and 7, the rack of the transmission gear assembly 132 is an inner rack, and the active gear 1312 is an outer gear. The inner rack means that teeth of the rack are formed at an inner edge of the rack, and the outer gear means that teeth of the gear are formed at an outer edge of the gear. The active gear 1312 disposed at the end of the first motor shaft 1311 is located at a moving space 1322 formed in the transmission gear assembly 132.

As shown in FIG. 7, the transmission gear assembly 132 includes an annular plate 1323 and a limiting bar 1324 connected to a first inner position and a second inner position of the annular plate 1323. A portion of an inner edge of the annular plate 1323 forms the rack 1321. The moving space 1322 is formed between the rack 1321 and the limiting bar 1324. The limiting bar 1324 limits the active gear 1312 between the first inner position and the second inner position of the annular plate 1323.

As shown in FIGS. 6 and 7, the cover 133 includes an annular cover wall 1331, a rim 1332 formed at one end of the cover wall 1331 and a connecting portion 1333 formed at one side of the cover wall 1331. The rim 1332 is secured to the annular plate 1323 through connecting elements, such as bolts, rivets, or fasteners.

As shown in FIGS. 6 and 7, the rim 1332 and the annular plate 1323 are accommodated in the base 110, and the cover wall 1331 extends into the base through an opening at a top portion thereof. The connecting portion 1333 is disposed externally to the base 110. The connecting portion 1333 and the rim 1332 clamp an edge of the opening at the top portion of the base 110, whereby the annular plate 1323 and the cover 133 are rotatably mounted to the base 110. In an alternative embodiment, the transmission gear assembly 132 and the cover 155 are rotatably mounted to the base 110 in other manners. For example, the base 110 has rails on which the transmission gear assembly 132 slides. The annular plate 1323 is horizontally disposed, and the first motor 131 is vertically disposed, whereby the first motor shaft 1311 is also vertically disposed. The annular plate 1323 is parallel to the horizontal plane, and the first motor 131 and the first motor shaft extend parallel to the z-axis.

As shown in FIGS. 6 and 7, the horizontal angle adjusting device 130 includes a first motor securing member 134 to which the first body 1313 is secured. The first motor securing member 134 is secured to the base 110. For example, the first motor securing member 134 is secured to the base 110 through bolts. In other embodiments, the first motor securing member 134 is secured to the base 110 through any conventional technical means.

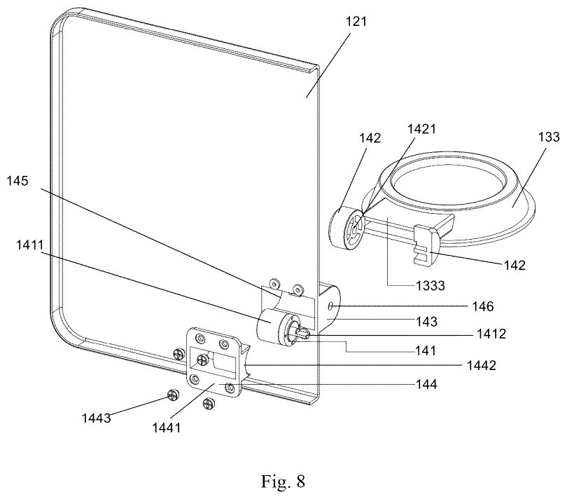

Referring to FIG. 8, the vertical angle adjusting device 140 includes a second motor 141 mounted to a back portion of the display 120 and an insertion portion formed at one side of the cover 133. The second motor 141 includes a second body 1411 and a second motor shaft 1412. An end of the second motor shaft 1412 is secured to the insertion portion 142. The second body 1411 rotates with respect to the second motor shaft 1412 when the second motor 141 is operated, whereby the display 120 rotates upwards or downwards to change the vertical angle thereof. In an example, the display 120 rotates upwards when the second motor 141 rotates in a clockwise direction, and the display 120 rotates downwards when the second motor 141 rotates in a counterclockwise direction. The vertical angel of the display 120 can be precisely controlled through the rotation of the second motor 141.

As shown in FIG. 8, the insertion portion 142 is formed at one end of the connecting portion 1333 of the cover 133. Physically, the vertical angle adjusting device 140 has two insertion portions 142 separated from each other. Each of the insertion portions 142 has an insertion hole 1421 formed on an inner side thereof. The second motor 141 is disposed between the two insertion portions 142. An end of the second motor shaft 1412 is secured to the insertion hole 1421 of the insertion portion 142.

In an alternative embodiment, the vertical angle adjusting device 140 is provided with only one insertion portion 142. In an alternative embodiment, the insertion portion 142 is directly formed on the cover wall 1331 of the cover 133 without the connecting portion 1333.

As shown in FIG. 8, the display 120 includes a back cover 121 and a motor securing base 144. The second motor 141 is horizontally disposed on the back cover 121, and the second motor shaft 1412 of the second motor 141 is also horizontally disposed. That is the second motor 141 and the second motor shaft 1412 both extend parallel to the horizontal plane.

The back cover 121 is provided with a mounting protrusion 143 protruding from a back surface thereof. A mounting groove 145 is formed in the mounting protrusion 143 and has an opening formed on a front surface of the back cover 121. A mounting hole 146 is formed in the mounting protrusion 143 and penetrate two opposite walls of the mounting protrusion 143. The motor securing base 144 includes a mounting portion 1441 and a securing portion 1442 extending from the mounting portion 1441 to the mounting groove 145 for securing the second body 1441.

The mounting portion 1441 is mounted to the opening of the mounting groove 145 through bolts. In other embodiments, the mounting portion 1441 is mounted to the opening of the mounting groove 145 through any conventional technical means.

The end of the second motor shaft 1412 extends through the mounting hole 146 and is afterwards secured to the insertion hole 1421 of the insertion portion 142. It is noticed that the end of the second motor shaft 1412 is maintained to be secured in the insertion hole 1421 of the insertion portion 142 without rotation when the second motor 141 is operated. Therefore, the second body 1411 rotates with respect to the second motor shaft 1412, whereby the second body 1411 rotates the back cover 121 about the second motor shaft 1412, and therefore rotates the display 120 upwards or downwards.

In an alternative embodiment, the second motor 141 is secured to the back cover 121 through any conventional technical means, for example, the second motor 141 is secured to the back cover 121 through fixing devices.

In the present invention, only the vertical angle adjusting device 140 is utilized to adjust the vertical angle of the display 120, such as upwards or downwards. Similarly, only the horizontal angle adjusting device 130 is utilized to adjust the horizontal angle of the display 120, such as rotating towards right-hand side or left-hand side. The vertical angle adjusting device 140 and the horizontal angle adjusting device 130 can also cooperate to adjust the vertical angle and the horizontal angle of the display 120, for example, the display 120 is rotated upwards and towards the right-hand side. That is the all-in-one computer of the present invention is provided with a dual-shaft rotational mechanism configured to adjust the vertical angle and the horizontal angle of the display 120 to ensure the display 120 rotating smoothly in various directions.

In a preferred embodiment, the display device of the all-in-one computer further includes a controller (not shown). The controller is electrically connected to the first motor or/and the second motor. The controller drives the first motor 131 or/and the second motor 141 in accordance with requirements or predetermined scheme to automatically adjust the horizontal angle or/and the vertical angle of the display 120. For example, a user may connect the controller through remote control apparatus (such as an application program installed in a mobile phone) to control a view angle of the display 120, thereby operating a remote adjustment of the view angle of the display. The user may also transmit commands to the controller through application programs or buttons, whereby the controller adjusts the view angle of the display.

In a preferred embodiment, the all-in-one computer further includes one or more sensors addition to the display device and the host. The sensor is electrically connected to the controller. The sensor can be exemplarily a microphone, a camera, a temperature sensor, an infrared sensor, a radar, a PIR sensor, etc. The controller drives the first motor or/and the second motor according to sensing signals from the sensor to automatically adjust the horizontal angle and the vertical angle of the display. For example, the camera is used to catch images of a user, and the controller recognizes a position of the user according to the images of the user. When the user is moving, the controller drives the first motor or/and the second motor according to the detected movement of the user to maintain the display device always facing the user. In another example, the microphone is used to receive voices from a user, and the controller recognizes a position of the user according to the voices of the user, and drives the first motor or/and the second motor according to the detected position of the user to maintain the display device always facing the user. In this way, the computer can automatically adjust the angle of the display through the sensor and the controller.

According to another aspect of the invention, the invention provides a display device capable of adjusting the view angle only. In this embodiment, the base 110 is only the supporting structure of the display and includes no host. The display 120 can be a tablet.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display device capable of adjusting a view angle, comprising:
a base;
a display;
a horizontal angle adjusting device being configured to adjust a horizontal angle of the display and comprising a first motor secured at the base, a transmission gear assembly and a cover secured in the transmission gear assembly, wherein the first motor comprises a first body, a first motor shaft and an active gear joined to an end of the first motor shaft, the transmission gear assembly comprises a rack, and the transmission gear assembly and the cover are rotatably mounted to the base; and
a vertical angle adjusting device being configured to adjust a vertical angle of the display and comprising a second motor mounted to a back portion of the display and at least one insertion portion formed on one side of the cover, wherein the second motor comprises a second body and a second motor shaft, an end of the second motor shaft is secured to the insertion portion, the second body rotates with respect to the second motor shaft when the second motor is operated, whereby the display is rotated vertically;
wherein the active gear engages the rack of the transmission gear assembly to rotate the transmission gear assembly and the cover, thereby the display rotates horizontally.

2. The display device as claimed in claim 1, wherein the rack of the transmission gear assembly is an inner rack the active gear is an outer gear, and the active gear is located in a moving space formed in the transmission gear assembly; the first motor is vertically disposed, whereby the first motor shaft is also vertically disposed.

3. The display device as claimed in claim 2, wherein the transmission gear assembly further comprises an annular plate, a limiting bar connected to a first inner position and a second inner position of the annular plate, a portion of an inner side of the annular plate forms the rack, the moving space is formed between the rack and the limiting bar, and the limiting bar limits the active gear between the first inner position and the second inner position.

4. The display device as claimed in claim 3, wherein the cover comprises a cover wall being annular, a rim formed at one end of the cover wall and a connecting portion formed at one side of the cover wall, and the insertion portion is formed at one end of the connecting portion;
the rim is secured at the annular plate, the rim and the annular plate is accommodated in the base, the cover wall extends into the base, the connecting portion is disposed externally to the base, the annular plate and the cover are rotatably mounted to the base;
the annular plate is horizontally disposed.

5. The display device as claimed in claim 1, wherein the horizontal angle adjusting device further comprises a first motor securing member secured to the base, and the first body is secured to the first motor securing member.

6. The display device as claimed in claim 1, wherein the display comprises a back cover to which the second motor is mounted, and the second motor shaft is horizontally disposed.

7. The display device as claimed in claim 6, wherein the vertical angle adjusting device comprises two of the insertion portions separated to each other, each of the insertion portions has an insertion hole, the second motor is disposed between the two insertion portions, and an end of the second motor shaft is secured to the insertion hole of the insertion portion.

8. The display device as claimed in claim 7, wherein the back cover of the display comprises a mounting protrusion protruding outwards therefrom, a mounting groove formed in the mounting protrusion and having an opening formed on a front surface of the back cover and a mounting hole penetrating two opposite lateral walls of the mounting protrusion;
wherein the display further comprises a motor securing base, the motor securing base comprises a mounting portion mounted to the opening of the mounting groove and a securing portion extending from the mounting portion to the mounting groove for securing the second body;
wherein an end of the second motor shaft extends through the mounting hole and is secured to the insertion hole of the insertion portion.

9. The display device as claimed in claim 6, further comprising:
a controller electrically connected to the first motor or/and the second motor and driving the first motor or/and the second motor in accordance with requirements or a predetermined scheme to automatically adjust the horizontal angle or/and vertical angle of the display.

10. The display device as claimed in claim 9, further comprising:
at least one sensor electrically connected to the controller;
wherein the controller drives the first motor or/and the second motor in accordance with a sensing signal from the sensor to automatically adjust the horizontal angle or/and vertical angle of the display.

11. An all-in-one computer, comprising:
a display device capable of adjusting a view angle, comprising:
a base;
a display;
a horizontal angle adjusting device being configured to adjust a horizontal angle of the display and comprising a first motor secured at the base, a transmission gear assembly and a cover secured in the transmission gear assembly, wherein the first motor comprises a first body, a first motor shaft and an active gear joined to an end of the first motor shaft, the transmission gear assembly comprises a rack, and the transmission gear assembly and the cover are rotatably mounted to the base; and
a vertical angle adjusting device being configured to adjust a vertical angle of the display and comprising a second motor mounted to a back portion of the display and at least one insertion portion formed on one side of the cover, wherein the second motor comprises a second body and a second motor shaft, an end of the second motor shaft is secured to the insertion portion, the second body rotates with respect to the second motor shaft when the second motor is operated, whereby the display is rotated vertically;
wherein the active gear engages the rack of the transmission gear assembly to rotate the transmission gear assembly and the cover, thereby the display rotates horizontally
a host disposed in the base or in the display.

12. The all-in-one computer as claimed in claim 11, wherein the rack of the transmission gear assembly is an inner rack the active gear is an outer gear, and the active gear is located in a moving space formed in the transmission gear assembly; the first motor is vertically disposed, whereby the first motor shaft is also vertically disposed.

13. The all-in-one computer as claimed in claim 12, wherein the transmission gear assembly further comprises an annular plate, a limiting bar connected to a first inner position and a second inner position of the annular plate, a portion of an inner side of the annular plate forms the rack, the moving space is formed between the rack and the limiting bar, and the limiting bar limits the active gear between the first inner position and the second inner position.

14. The all-in-one computer as claimed in claim 13, wherein the cover comprises a cover wall being annular, a rim formed at one end of the cover wall and a connecting portion formed at one side of the cover wall, and the insertion portion is formed at one end of the connecting portion;
the rim is secured at the annular plate, the rim and the annular plate is accommodated in the base, the cover wall extends into the base, the connecting portion is disposed externally to the base, the annular plate and the cover are rotatably mounted to the base;
the annular plate is horizontally disposed.

15. The all-in-one computer as claimed in claim 11, wherein the horizontal angle adjusting device further comprises a first motor securing member secured to the base, and the first body is secured to the first motor securing member.

16. The all-in-one computer as claimed in claim 11, wherein the display comprises a back cover to which the second motor is mounted, and the second motor shaft is horizontally disposed.

17. The all-in-one computer as claimed in claim 16, wherein the vertical angle adjusting device comprises two of the insertion portions separated to each other, each of the insertion portions has an insertion hole, the second motor is disposed between the two insertion portions, and an end of the second motor shaft is secured to the insertion hole of the insertion portion.

18. The all-in-one computer as claimed in claim 17, wherein the back cover of the display comprises a mounting protrusion protruding outwards therefrom, a mounting groove formed in the mounting protrusion and having an opening formed on a front surface of the back cover and a mounting hole penetrating two opposite lateral walls of the mounting protrusion;
wherein the display further comprises a motor securing base, the motor securing base comprises a mounting portion mounted to the opening of the mounting groove and a securing portion extending from the mounting portion to the mounting groove for securing the second body;
wherein an end of the second motor shaft extends through the mounting hole and is secured to the insertion hole of the insertion portion.

19. The all-in-one computer as claimed in claim 16, wherein the display device further comprising a controller electrically connected to the first motor or/and the second motor and driving the first motor or/and the second motor in accordance with requirements or a predetermined scheme to automatically adjust the horizontal angle or/and vertical angle of the display.

20. The all-in-one computer as claimed in claim 19, wherein the display device further comprising at least one sensor electrically connected to the controller;
wherein the controller drives the first motor or/and the second motor in accordance with a sensing signal from the sensor to automatically adjust the horizontal angle or/and vertical angle of the display.
